(19) United States
(12) Patent Application Publication
(10) Pub. No.: US 2023/0144271 A1
(43) Pub. Date: May 11, 2023

(54) SYSTEM AND METHOD OF INDUCTION HEATING A GOLF BALL

(71) Applicant: William K. Peregoy, Lillington, NC (US)

(72) Inventor: William K. Peregoy, Lillington, NC (US)

(21) Appl. No.: 17/981,531

(22) Filed: Nov. 7, 2022

Related U.S. Application Data
(60) Provisional application No. 63/276,963, filed on Nov. 8, 2021.

(51) Int. Cl. A63B 47/00; H05B 6/36; H05B 6/04

(52) U.S. Cl. CPC A63B 47/005; H05B 6/365; H05B 6/04; A63B 2102/32

(57) ABSTRACT

The disclosed system can comprise a device that can be used to provide induction heating to one or more golf balls. The disclosed device comprises at least one induction coil and a housing that holds one or more golf balls. In some embodiments, the induction coil can take one or more turns around the housing. The induction coil generates a magnetic field surrounding the golf ball, inducing eddy currents in the central magnetic reactor within the golf ball interior. As a result, the golf ball is quickly, cleanly, and consistently heated without physical contact between the coil and the golf ball.

### CROSS-REFERENCE TO RELATED APPLICATIONS

This application claims priority to U.S. Provisional Patent Application No. 63/276,963, filed Nov. 8, 2021, the entire contents of which are hereby incorporated by reference.

### TECHNICAL FIELD

The presently disclosed subject matter is generally directed to a system and method of induction heating a golf ball.

### BACKGROUND

It is well known that when a golf ball that is uniformly heated to a temperature of about 100° F., will travel farther than a cold golf ball when hit by a golf club under identical conditions. Specifically, preheating a golf ball decreases the total temperature change to which the golf ball is exposed and minimizes the thermal expansion in the golf ball cover. Therefore, a golfer has an advantage if they can maintain their golf balls at an increased temperature during play on the golf course in colder weather. Previous devices for heating golf balls are limited to containers that provide an external heating element that is directly applied to the exterior of the golf ball. As a result, heating of the golf ball with prior art devices is inconsistent and the temperature varies depending on how close a golf ball is to an external heating unit. It would therefore be beneficial to provide a system and method of heating a golf ball that overcomes the deficiencies in the prior art, providing uniform heating of a golf ball.

### SUMMARY

In some embodiments, the presently disclosed subject matter is directed to a golf ball. Specifically, the golf ball comprises a core defined by a magnetic reactor positioned in a center of the core, and a cover layer disposed about an exterior surface of the core.

In some embodiments, the golf ball further includes at least one mantle layer positioned in between the core and the cover layer.

In some embodiments, the cover comprises an external coating layer.

In some embodiments, the magnetic reactor comprises a magnetic material.

In some embodiments, the magnetic reactor comprises a ferromagnetic material.

In some embodiments, the magnetic reactor comprises iron, iron-comprising materials, cobalt nickel, strontium gadolinium, brass, aluminum, copper, steel, or combinations thereof.

In some embodiments, the magnetic reactor comprises one or more semiconducting materials selected from silicon carbide, carbon, graphite, or combinations thereof.

In some embodiments, the magnetic reactor is configured as a solid material, a filament, or a network of mesh.

In some embodiments, the magnetic reactor is configured as a battery.

In some embodiments, the golf ball comprises aerogel or Airloy materials.

In some embodiments, the presently disclosed subject matter is directed to a method of heating at least one golf ball. Specifically, the method comprises positioning an induction coil adjacent to one or more golf balls to be heated, each golf ball defined by a core defined by a magnetic reactor positioned in a center of the core and a cover layer disposed about an exterior surface of the core. The method also includes applying power to the induction coil, whereby the induction coil generates a magnetic field surrounding the golf ball, inducing eddy currents in the magnetic reactor. The one or more golf balls are heated from the core and radiates through the remainder of each golf ball.

In some embodiments, the one or more golf balls are supported by a housing about which the induction coil is positioned.

In some embodiments, the induction coil is wound around the housing.

In some embodiments, the induction coil supports the one or more golf balls.

In some embodiments, the induction coil comprises a shell in direct contact with each golf ball.

In some embodiments, the induction coil is controlled by circuitry to regulate temperature of the golf ball.

In some embodiments, the induction coil is controlled by power management controls to allow a user to input temperature, time, on/off, or combinations thereof.

In some embodiments, magnetic flux guides are used to direct and focus electromagnetic energy from the induction coil to the magnetic reactor.

In some embodiments, the presently disclosed subject matter is directed to an induction heater comprising an induction coil operatively connected to a power source, and a shell positioned directly adjacent to the induction coil, wherein the shell comprises an interior compartment sized and shaped to house a product to be heated. The product to be heated includes a magnetic reactor within a core of the product.

In some embodiments, the heater includes the power source.

In some embodiments, the magnetic reactor comprises iron, cobalt nickel, strontium gadolinium, brass, aluminum, copper, steel, silicon carbide, carbon, graphite, or combinations thereof.

In some embodiments, the induction coil is wrapped one or more times around the shell.

In some embodiments, the induction coil directly contacts an outer surface of the shell.

In some embodiments, the induction coil is constructed from copper, aluminum, copper coated carbon fiber, nickel, metal coated carbon fiber, copper or aluminum or nickel coated fiberglass, stainless steel filaments, copper strands, or combinations thereof.

In some embodiments, the shell is constructed from a ceramic material, foam, rubber, polymeric material, or combinations thereof.

In some embodiments, the power source is a source of AC current.

In some embodiments, the product to be heated is a golf ball.

In some embodiments, the heater includes circuitry to regulate the temperature of the product to be heated.

In some embodiments, the presently disclosed subject matter is directed to a method of heating a product with the disclosed induction heater. Specifically, the method comprises positioning the product to be heated within the interior compartment of the shell, and activating the power source to generate a magnetic field in the induction coil, thereby generating heat that is applied to the product to be heated.

In some embodiments, the product to be heated is heated to a temperature of about 100° F.

In some embodiments, the product to be heated is a golf ball.

### BRIEF DESCRIPTION OF THE DRAWINGS

FIG. 1a is a perspective view of a golf ball in accordance with some embodiments of the presently disclosed subject matter.

FIG. 1b is a cross-sectional view of the golf ball of FIG. 1a in accordance with some embodiments of the presently disclosed subject matter.

FIGS. 2a and 2b are cross-sectional views of a golf ball comprising an inner and outer core layer in accordance with some embodiments of the presently disclosed subject matter.

FIG. 3a is a cross-sectional view of a golf ball comprising a core layer, cover layer, and a mantle layer in accordance with some embodiments of the presently disclosed subject matter.

FIG. 3b is a cross-sectional view of a golf ball comprising a core layer, cover layer, and a plurality of mantle layers in accordance with some embodiments of the presently disclosed subject matter.

FIG. 4 is a cross-sectional view of a golf ball in accordance with some embodiments of the presently disclosed subject matter.

FIG. 5a is a perspective view of a magnetic reactor configured as a solid in accordance with some embodiments of the presently disclosed subject matter.

FIG. 5b is a fragmentary view of a magnetic reactor configured as a continuous mesh in accordance with some embodiments of the presently disclosed subject matter.

FIG. 5c is a fragmentary view of a magnetic reactor configured as a filament in accordance with some embodiments of the presently disclosed subject matter.

FIG. 6a is a perspective view of an induction coil configured around a housing in accordance with some embodiments of the presently disclosed subject matter.

FIG. 6b is a cross-sectional view of an induction coil configured around a golf ball in accordance with some embodiments of the presently disclosed subject matter.

FIG. 6c is a cross-sectional view of an induction coil and shell configured around a golf ball in accordance with some embodiments of the presently disclosed subject matter.

FIG. 7a depicts an induction coil connected to a power source in accordance with some embodiments of the presently disclosed subject matter.

FIG. 7b depicts the induction coil of FIG. 7a wrapped around a golf ball in accordance with some embodiments of the presently disclosed subject matter.

FIG. 7c depicts the system of FIG. 7b with circuitry controls in accordance with some embodiments of the presently disclosed subject matter.

FIGS. 8a and 8b are front plan views of open and closed configuration flux guides in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

“Induction heating” refers to the process of heating an electrically conductive material (e.g., metals) by electromagnetic induction, through heat transfer passing through an induction coil that creates an electromagnetic field within the coil. Thus, induction heating is a fast and efficient non-contact method for heating electrically conductive materials. The presently disclosed subject matter includes a device that can be used to heat a golf ball via induction heating. Specifically, the device includes at least one induction coil. Alternating electric current is passed through the induction coil to generate an electromagnetic field. The eddy currents induced in the golf ball by the electromagnetic field cause the golf ball to become heated.

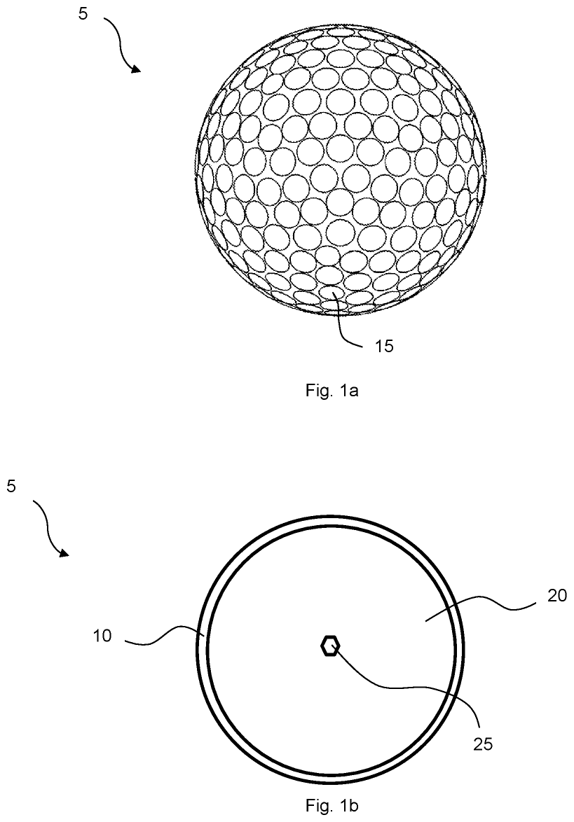

FIGS. 1a and 1b illustrate one embodiment of golf ball 5 that can be heated by an induction device as described herein. The term “golf ball” as used herein refers to any generally spherically shaped ball that can be used in playing the game of golf. As shown, the golf ball includes outer cover 10 comprising a plurality of divots 15, and core 20 comprising at least one magnetic reactor 25. The magnetic reactor cooperates with a primary coil configured in an induction device to heat the golf ball the inside out. The term “magnetic reactor” refers to a reactor comprising one or more coils that generate a magnetic field. It should be appreciated that while the present disclosure describes a system and method of heating a golf ball, the disclosed system and method can be used to heat or warm any ball (e.g., baseball, tennis ball, soccer ball, football, etc.).

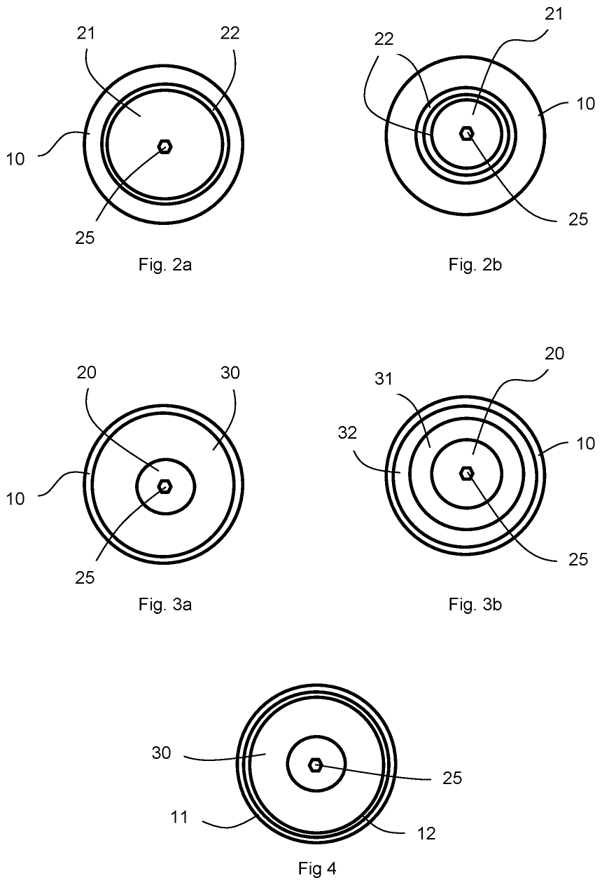

As shown in FIG. 1b, the golf ball includes central core 20 that comprises at least one magnetic reactor. The term “core” refers to the elastic center of a golf ball, which can have a unitary construction. Alternatively, the core can have a layered construction with spherical center 21 and one or more additional core layers 22, as shown in FIGS. 2a and 2b.

Each core layer can include aerogel materials, Airloy materials, synthetic and/or natural rubbers, thermoset polymers such as thermoset polyurethanes and thermoset polyureas, as well as thermoplastic polymers including thermoplastic elastomers such as unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, unimodal ionomers, bimodal ionomers, modified unimodal ionomers, modified bimodal ionomers, thermoplastic polyurethanes, thermoplastic polyureas, polyesters, copolyesters, polyam ides, copolyam ides, polycarbonates, polyolefins, polyphenylene oxide, polyphenylene sulfide, diallyl phthalate polymer, polyim ides, polyvinyl chloride, polyimide-ionomer, polyurethane-ionomer, polyvinyl alcohol, polyarylate, polyacrylate, polyphenylene ether, impact-modified polyphenylene ether, polystyrene, high impact polystyrene, acrylonitrile-butadiene-styrene copolymer styrene-acrylonitrile (SAN), acrylonitrile-styrene-acrylonitrile, styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, and polysiloxane and any and all combinations thereof.

In some embodiments, the golf ball can include mantle layer 30 disposed between the core and outer cover, as shown in FIG. 3a. A mantle layer can partially or fully surround the core. Further, a golf ball can include two or more mantle layers (e.g., inner mantle layer 31 and outer mantle layer 32), as shown in FIG. 3b. Thus, golf ball 5 can include any number of mantle layers. The mantle can comprise any suitable material, such as (but not limited to) dynamically vulcanized thermoplastic elastomer, functionalized styrene-butadiene elastomer, thermoplastic polyurethane, thermoplastic polyetherester or polyetheramide, thermoplastic ionomer resin, thermoplastic polyester, metallocene polymer or blends thereof.

The term “cover layer” or “cover” refers to any layer or layers of the golf ball adjacent to or surrounding (partially surrounding or entirely surrounding), the outermost mantle layer. The term “outer cover layer” refers to the outermost cover layer 11 of the golf ball that is directly in contact with paint and/or ink on the surface of the golf ball and on which the dimple pattern is placed. In some embodiments, the cover can include two or more layers. In these embodiments, the term “inner cover” refers to any inner cover layer 12 positioned between the outermost mantle layer and the outer cover layer, as shown in FIG. 4.

Cover layer 10 can have a thickness of about 0.01-0.1 inches (e.g., at least/no more than about 0.01, 0.02, 0.03, 0.04, 0.05, 0.06, 0.07, 0.08, 0.09, or 0.1 inches). However, it should be appreciated that the presently disclosed subject matter is not limited, and the golf ball cover layer can be configured outside the range given herein.

The cover layer can be made from any suitable material, such as one or more thermoplastic elastomers, thermoset polyurethanes, thermoplastic polyurethanes, unimodal ionomers, bimodal ionomers, modified unimodal ionomers, modified bimodal ionomers, or combinations thereof.

In some embodiments, the cover layer can be formed from a relatively soft thermoset material to replicate the soft feel and high spin play characteristics of a balata ball when used for pitch and other “short game” shots. In particular, cover layer 10 can have a Shore D hardness of from about 30 to about 60 (e.g., at least/no more than about 30, 35, 40, 45, 50, 55, or 60). However, it should be appreciated that the disclosed golf ball can have a cover layer greater than or less than the Shore D hardness range given above.

The materials of the cover layer can have a degree of abrasion resistance to be suitable for use as a golf ball cover. In addition, a coating layer can be disposed on or adjacent to the outer cover layer. For example, the coating layer can be a thermoplastic resin-based paint and/or a thermosetting resin-based paint. Examples of such paints include (but are not limited to) vinyl acetate resin paints, vinyl acetate copolymer resin paints, EVA (ethylene-vinyl acetate copolymer resin) paints, acrylic ester (co)polymer resin paints, epoxy resin paints, thermosetting urethane resin paints, thermoplastic urethane resin paints, thermosetting acrylic resin paints, and unsaturated polyester resin paints. The coating layer can be transparent, semi-transparent, or translucent.

Importantly, core 10 comprises magnetic reactor 30. The term “magnetic reactor” refers to any item used in the core of a golf ball that can function as a secondary coil in an induction heating system. For example, the magnetic reactor can be configured as a portion of magnetic material. The term “magnetic” refers to any material that is capable of being altered in a magnetic field. In some embodiments, the materials used to form the magnetic reactor can be selected from one or more ferromagnetic materials. The term “ferromagnetic” refers to the characteristic of having a strong sensitivity to a magnetic field and also the ability to retain the magnetic properties when the magnetic field is removed. Suitable materials from which the magnetic reactor can be formed can include (but are not limited to) iron, iron-comprising materials, cobalt nickel, strontium gadolinium, brass, aluminum, copper, steel, semiconducting material (silicon carbide, carbon, graphite), or combinations thereof. In some embodiments, the magnetic reactor can be a magnetic ball bearing.

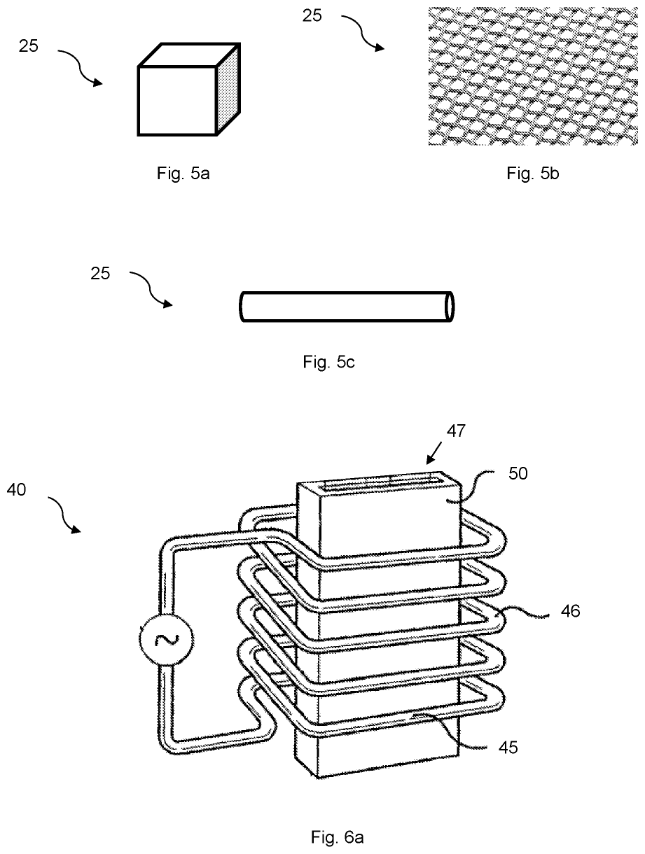

The magnetic reactor can be configured in any desired configuration, such as a solid portion, as shown in FIG. 5a. The magnetic reactor can have any desired cross-sectional shape, such as rounded, square, rectangular, triangular, abstract, and the like.

In other embodiments, the magnetic reactor can be configured as a network of mesh, as shown in FIG. 5b. Further, the magnetic reactor can be configured as a continuous filament or fiber positioned in any desired shape, as shown in FIG. 5c.

The magnetic reactor can comprise at least about 1/1000 of the volume of the golf ball core. Thus, the magnetic reactor can make up about 1/1000, 1/900, 1/800, 1/700, 1/600, 1/500, 1/400, 1/300, 1/200, 1/100, 1/50, 1/25, or more of the volume of the core.

In some embodiments, the magnetic reactor can include a battery in place of (or in addition to) the magnetic or ferromagnetic materials. The term “battery” refers to a source of electric power comprising one or more electrochemical cells with external connections for heating the golf ball.

Golf ball 5 can be constructed using any suitable method, such as (but not limited to) injection molding, casting, thermosetting. For example, the golf ball cover layer(s) can be initially injection molded, followed by subsequent processing at higher temperatures and pressures to induce crosslinking and curing.

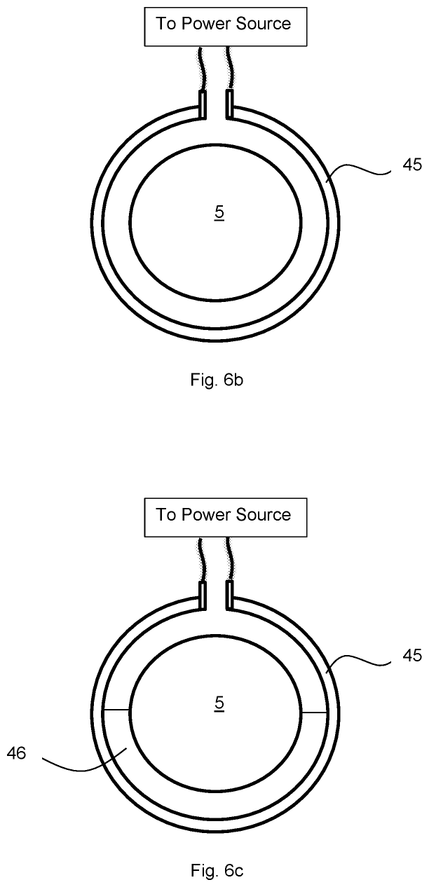

The basic components of the disclosed system include a heater defined by an induction coil connected to an alternating current (AC) source, and at least one golf ball that is to be heated. Thus, the disclosed system can include device 40 that can be used to provide induction heating to golf ball 5. FIG. 6a illustrates one embodiment of the disclosed device comprising at least one induction coil 45 and housing 50 that holds one or more golf balls 5 within the interior. The term “induction coil” refers to a conductive material that is wound one more times or is otherwise shaped, molded, printed, electroformed, or configured to form a spiral, a circular pattern, or similar form. The term “induction coil” can also include a plurality of coils. The coil can include at least two contact regions generally located at the coil end regions where connection to an electrical circuit can be made to enable power to be provided. To achieve a high desired level of wireless inductive charging performance, the material may be wound at least two times around a golf ball as disclosed herein.

In some embodiments, each housing includes interior 47 that can house one or more golf balls. Alternatively or in addition, the coil can be wrapped around the golf ball directly. In some embodiments, the induction coil can take one or more turns 46 around the housing (or golf ball), as shown in FIG. 6a. The induction coil generates a magnetic field surrounding the golf ball, inducing eddy currents in the central magnetic reactor within the golf ball interior. As a result, the golf ball is quickly, cleanly, and consistently heated without physical contact between the coil and the golf ball.

The induction coil can be constructed from any suitable material, such as (but not limited to) copper, aluminum, copper coated carbon fiber, nickel, metal coated carbon fiber, copper or aluminum or nickel coated fiberglass (or other suitable substrate fiber), or as multiplicity of filaments or fibers such as stainless steel filaments, copper strands, and the like, or any electrically conductive material (such as a metal or combination of metals).

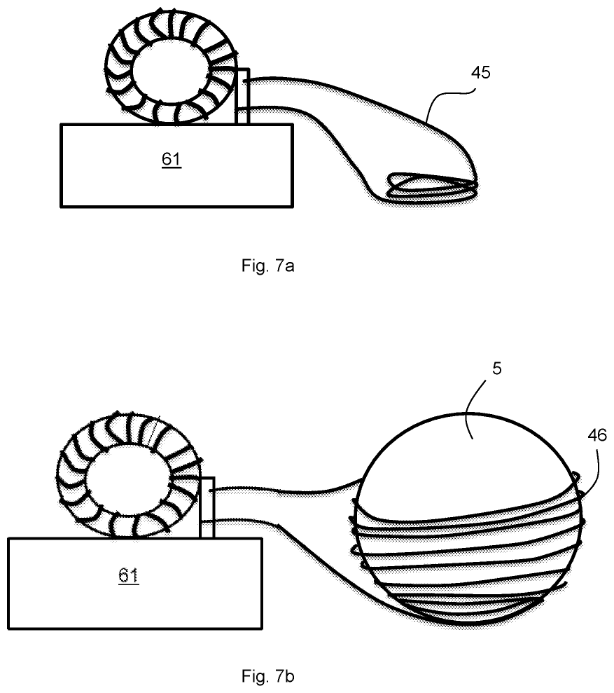

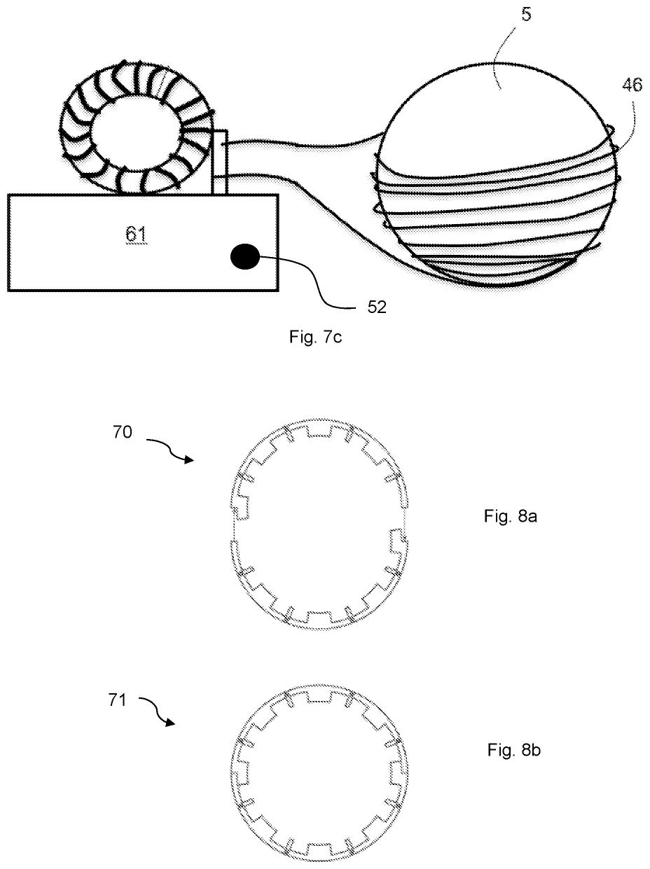

In some embodiments, the system can be configured without housing 50, as illustrated in FIG. 6b. Particularly, a golf ball can be supported by induction coil 45 providing a clear pathway of the magnetic field to reach the core of the golf ball. In these embodiments, induction coil 45 can include shell 46 that cradles the golf ball, as shown in FIG. 6c. The term “shell” refers to any coating or over-molding that covers an exterior surface of coil 45. Advantageously, the shell can provide an added safety feature, protecting a user from contact with the induction coil. Shell 46 can be constructed from any suitable material, such as (but not limited to) ceramics, foam, rubber, polymeric material, and the like. FIGS. 7a and 7b illustrate another embodiment of induction coil 45 configured to at least partially wrap around golf ball 5. The induction coil 45 is attached to power source 61, as shown (e.g., batteries, AC (alternating current), etc.). Any power source can be used. As shown, the induction coil can be wound around a golf ball, where the coil attaches to the system, providing power to then heat a golf ball (or plurality of golf balls). The induction coil can directly contact the outer surface of the golf ball in some embodiments. In other embodiments, the induction coil can be positioned adjacent to the outer surface of a golf ball, but it does not directly touch the golf ball.

It should be appreciated that the device can have any desired shape and is not limited to shapes set forth in the Figures, so long as the housing can retain one of more golf balls 5. For example, device 40 can have a spherically symmetrical shape in some embodiments.

Optionally, the disclosed system can also include circuitry 52 to regulate temperature of the golf ball, as shown in FIG. 7c. For example, a pre-set temperature can be set (e.g., about 100° F.) and the circuitry can detect when the temperature range has been achieved. Once an upper temperature limit has been reached, the circuitry can then decrease the magnetic field of the induction coil and/or otherwise decrease the amount of heat produced by the magnetic reactor within the golf ball cord. The system can also include power management controls that allow a user to input temperature, time, on/off, and the like.

The disclosed device can include magnetic flux guides to redirect and focus energy more efficiently to the core of golf ball 5. The flux guides can route off-axis components of the magnetic field to a desired location (e.g., the core of the golf ball). In some embodiments, the flux guides can also shield portions of the golf ball magnetically if desired by the user. The term “flux guide” refers to a structure shaped to focus magnetic fields to one or more induction coils. FIGS. 8a and 8b illustrate one embodiment of open and closed configuration flux guides 70, 71, respectively. The flux generator can be permanently or releasably attached to an outer surface of the device (e.g., around the induction coil, adjacent to the induction coil, around or adjacent to the shell, adjacent to the power source, etc.).

In practice, induction heating can be used to heat a golf ball to a predetermined temperature (e.g., about 100° F. in some embodiments). Thus, the disclosed heating device and system can be used to heat a golf ball to at least about (or no more than about) 70, 75, 80, 85, 90, 95, 100, 105, 110, 115, 120, 125, 130, 135, 140, 145, or 150° F. Specifically, magnetic reactor 25 positioned within the core of golf ball 5 is heated through heat transfer passing from the power source through induction coil 45, creating an electromagnetic field. An induction heater comprising an electromagnet and an electronic oscillator that passes a high frequency alternating current (AC) through the electromagnet can be used. The rapidly alternating magnetic field penetrates the golf ball, generating electric currents inside the conductor (called eddy currents). The eddy currents flow through the resistance of the golf call and heat it by Joule heating. “Joule heating” refers to resistive heating within a conduction (and can be synonymous with “induction heating”). An important feature of the disclosed method is that the heat is generated inside the golf ball instead of by an external heat source via heat conduction. As a result, the golf ball can be heated very rapidly. In addition, external contact is not required.

When induction heating is applied to a golf ball, the frequency of the AC in the induction coil is inversely proportional to the depth that the magnetic field penetrates the work piece. For example, low AC frequencies of about 5 KHz to about 30 KHz are effective for heating relatively thicker materials. Higher AC frequencies of about 100 KHz to about 400 KHz are effective to penetrate smaller or shallower parts.

Beneficially, after the golf ball has been heated to a desired level, it can be removed from the device and/or system and used in the game of golf. As noted above, heated golf balls advantageously travel farther, especially in cooler external temperatures (e.g., winter months). After the golf ball has been used, it can again be heated using the disclosed system (e.g., positioned with the induction coils wrapped around the golf ball or adjacent to the induction coil) to re-heat the golf ball to a desired level.

Exemplary embodiments of the methods and components of the presently disclosed subject matter have been described herein. As noted elsewhere, these embodiments have been described for illustrative purposes only, and are not limiting. Other embodiments are possible and are covered by the presently disclosed subject matter. Such embodiments will be apparent to persons skilled in the relevant art(s) based on the teachings contained herein. Thus, the breadth and scope of the present invention should not be limited by any of the above-described exemplary embodiments but should be defined only in accordance with the following claims and their equivalents.

What is claimed is:

1. An induction heater comprising:
an induction coil operatively connected to a power source;
a shell positioned directly adjacent to the induction coil, wherein the shell comprises an interior compartment sized and shaped to house a product to be heated;
wherein the product to be heated includes a magnetic reactor within a core of the product.

2. The induction heater of claim 1, further comprising the power source.

3. The induction heater of claim 1, wherein the magnetic reactor comprises iron, cobalt nickel, strontium gadolinium, brass, aluminum, copper, steel, silicon carbide, carbon, graphite, or combinations thereof.

4. The induction heater of claim 1, wherein the induction coil is wrapped one or more times around the shell.

5. The induction heater of claim 1, wherein the induction coil directly contacts an outer surface of the shell.

6. The induction heater of claim 1, wherein the induction coil is constructed from copper, aluminum, copper coated carbon fiber, nickel, metal coated carbon fiber, copper or aluminum or nickel coated fiberglass, stainless steel filaments, copper strands, or combinations thereof.

7. The induction heater of claim 1, wherein the shell is constructed from a ceramic material, foam, rubber, polymeric material, or combinations thereof.

8. The induction heater of claim 2, wherein the power source is a source of AC current.

9. The induction heater of claim 1, wherein the product to be heated is a golf ball.

10. The induction heater of claim 1, further comprising circuitry to regulate the temperature of the product to be heated.

11. A method of heating a product with the induction heater of claim 1, the method comprising:
positioning the product to be heated within the interior compartment of the shell;
activating the power source to generate a magnetic field in the induction coil, generating heat that is applied to the product to be heated.

12. The method of claim 11, wherein the product to be heated is heated to a temperature of about 100° F.

13. The method of claim 11, wherein the product to be heated is a golf ball.

14. The method of claim 11, wherein the power source is an AC power source.

15. The method of claim 11, wherein the induction coil directly contacts an outer surface of the shell.

16. The method of claim 11, wherein the magnetic reactor comprises iron, cobalt nickel, strontium gadolinium, brass, aluminum, copper, steel, silicon carbide, carbon, graphite, or combinations thereof.

17. The method of claim 11, wherein the induction coil is wrapped one or more times around the shell.

18. The method of claim 11, wherein the induction coil directly contacts an outer surface of the shell.

19. The method of claim 11, wherein the induction coil is constructed from copper, aluminum, copper coated carbon fiber, nickel, metal coated carbon fiber, copper or aluminum or nickel coated fiberglass, stainless steel filaments, copper strands, or combinations thereof.

20. The method of claim 11, wherein the shell is constructed from a ceramic material, foam, rubber, polymeric material, or combinations thereof.
